(19) United States
(12) Patent Application Publication
(10) Pub. No.: US 2012/0134626 A1
(43) Pub. Date: May 31, 2012

(54) OPTOELECTRONIC MODULE AND LIGHT TRANSMITTING AND RECEIVING MODULE HAVING SAME

(75) Inventor: I-THUN LIN, Tu-Cheng (TW)

(73) Assignee: HON HAI PRECISION INDUSTRY CO., LTD., Tu-Cheng (TW)

(21) Appl. No.: 13/094,768

(22) Filed: Apr. 26, 2011

(30) Foreign Application Priority Data
Nov. 29, 2010 (TW) 99141160

(51) Int. Cl. G02B 6/32; G02B 6/26

(52) U.S. Cl. 385/33; 385/31

(57) ABSTRACT

An optoelectronic module for optically coupling with an optical fiber connector is disclosed. The optical fiber connector includes a light input optical fiber and a light output optical fiber. The optoelectronic module includes a circuit board, a photodiode mounted on the circuit board, a laser diode mounted on the circuit board and a light directing member mounted on the circuit board. The light directing member includes a first surface and a second surface substantially perpendicular to the first surface. The first surface faces the light input optical fiber and the light output optical fiber, the second surface faces the photodiode and the laser diode. The light directing member includes a light reflecting surface configured for reflecting light from the light input optical fiber to the photodiode and reflecting light from the laser diode to the light output optical fiber.

### BACKGROUND

1. Technical Field

The present disclosure relates to an optoelectronic module and light transmitting and receiving module having the optoelectronic module.

2. Description of Related Art

A light transmitting and receiving module usually includes an optical fiber connector and an optoelectronic module connected to the optical fiber connector. The optical fiber connector includes a light input optical fiber, a light output optical fiber. The optoelectronic module a photodiode and a laser diode. The photodiode is configured for receiving signals from the signal input optical fiber, and the laser diode is configured for transmitting signals to the signal output optical fiber. The photodiode and the laser diode are electrically connected to a circuit board, the light input/output direction of the photodiode/laser diode is perpendicular to the surface of the circuit board which the photodiode and the laser diode are fixed on. And typically, the light input optical fiber and the light output optical fiber are disposed parallel on the surface of the circuit board. Therefore, in assembly, the ends of the light input optical fiber and the light output optical fiber near the photodiode and the laser diode need to be bent to a predetermined angle.

However, the assembly of the light transmitting and receiving module, and the light input/output optical fiber may be damaged because of deformation.

What is needed therefore is an optoelectronic module and light transmitting and receiving module having the optoelectronic module.

### BRIEF DESCRIPTION OF THE DRAWINGS

The components of the drawings are not necessarily drawn to scale, the emphasis instead being placed upon clearly illustrating the principles of the embodiments of the optoelectronic module and light transmitting and receiving module having the same. Moreover, in the drawings, like reference numerals designate corresponding parts throughout several views.

FIG. 1 is an isometric view of a light transmitting and receiving module having an optoelectronic module, according to an exemplary embodiment of the present disclosure.

FIG. 2 is an exploded view of the light transmitting and receiving module of FIG. 1.

FIG. 3 is similar to FIG. 2, but shows the light transmitting and receiving module from another angle.

FIG. 4 is a sectional view of the light transmitting and receiving module, taken along line IV-IV of FIG. 1.

### DETAILED DESCRIPTION

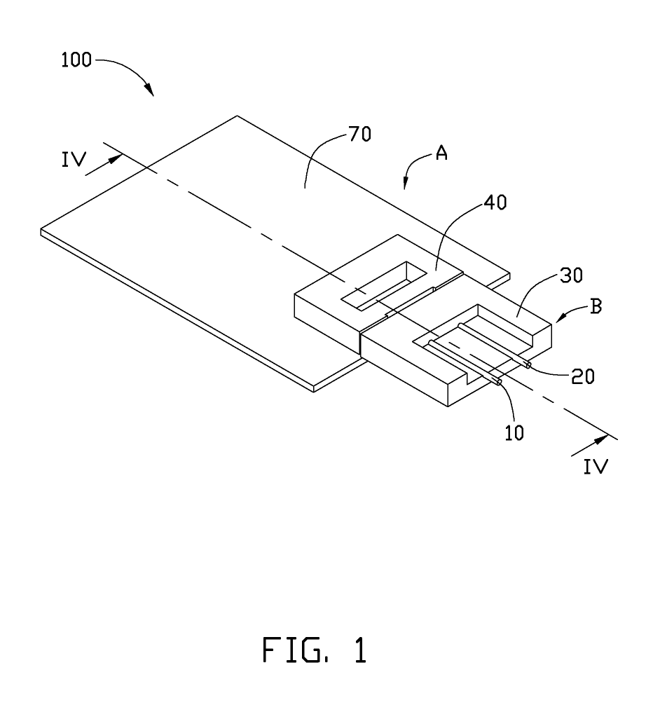

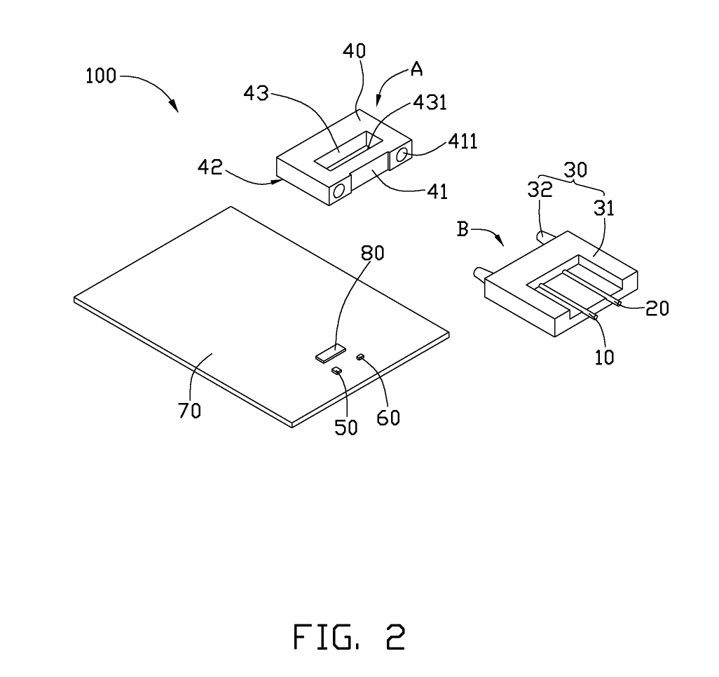

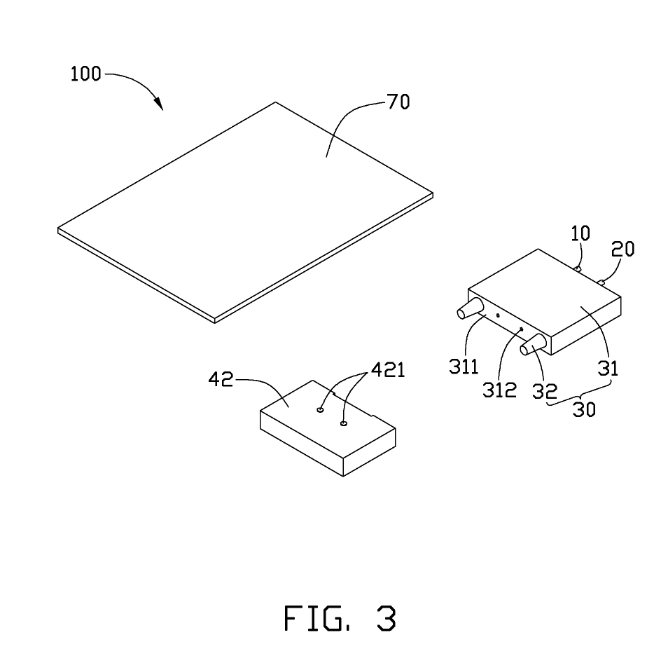

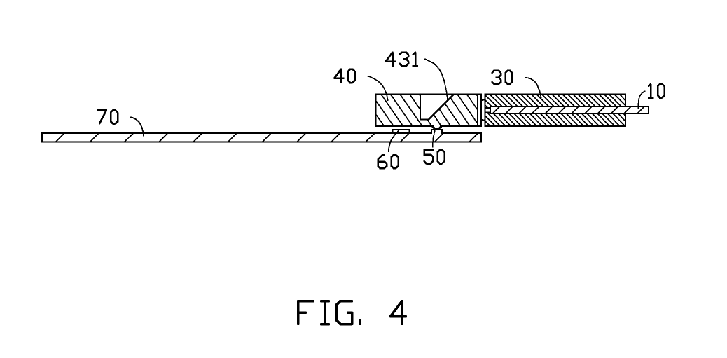

Referring to FIGS. 1-4, an optical fiber transmitting system 100, according to an exemplary embodiment, is shown. The optical fiber transmitting system 100 includes an optical fiber connector A and an optoelectronic module B connected to the optical fiber connector A.

The optical fiber connector A includes a light input optical fiber 10, a light output optical fiber 20 and a connector body 30. The optoelectronic module B includes a signal refractor 40, a photodiode 50, a laser diode 60 and a circuit board 70.

The light input optical fiber 10 inputs optical signals to the photodiode 50, and the light output optical fiber 20 outputs optical signals transmitted from the laser diode 60.

The connector body 30 fixes the light input optical fiber 10 and the light output optical fiber 20. The connector body 30 includes a main body 31 and two engaging posts 32 formed on the main body 31. The main body 31 is substantially cuboid shaped and includes an end surface 311 opposing the light directing member 40. The main body 31 defines two through holes 312, the through hole 312 pass through the end surface 311 and a surface opposite to the end surface 311 of the main body 31. The engaging posts 32 are formed on the end surface of the main body 31, in this embodiment, the engaging posts 32 and the main body 31 are integrated with each other.

The light directing member 40 is substantially shaped as a cuboid. The light directing member 40 includes a first surface 41 and a second surface 42 substantially perpendicular to the first surface 41. The first surface 41 faces the light input optical fiber 10 and the light output optical fiber 20, the second surface 42 faces the photodiode 50 and the laser diode 60. The first surface 41 defines two engaging holes 411 therein corresponding to the engaging posts 32. The light directing member 40 includes two lens portions 421 formed on the second surface 42 thereof. One of the lens portions 421 is optically aligned with the photodiode 50, and the other lens portion 421 is optically aligned with the laser diode. In this embodiment, the lens portions 421 are integrally formed with the second surface 42 of the light directing member 40. The light directing member 40 defines a slot 43 therein. The slot 43 includes a light reflecting surface 431 therein. The angle between the light reflecting surface 431 and the first surface 41 is approximately 45 degrees, and the angle between the light reflecting surface 431 and the second surface 42 is approximately 45 degrees. The lengthwise direction of the slot 43 is substantially parallel to the first surface 41, and the length of the slot is greater than the distance between the two through holes 312 of the connector body 30. In this embodiment, the light directing member 40 is transparent.

The photodiode 50 is configured for receiving optical signals from the light input optical fiber 10 and converting the optical signals into electrical signals. The photodiode 50 is electrically connected to the circuit board 40, and the signal input direction of the photodiode 50 is substantially perpendicular to the circuit board 40.

The laser diode 60 is configured for converting electrical signals into optical signals and transmitting the optical signals to the light output optical fiber 20. The laser diode 60 is electrically connected to the circuit board 40, and the signal output direction of the laser diode 60 is substantially perpendicular to circuit board 40. In this embodiment, the laser diode 60 is a vertical cavity surface emitting laser (VCSEL) device.

The circuit board 70 is configured for controlling the laser diode 60 to transmit optical signals to the light output optical fiber 20 base on control instructions, and transmitting the electrical signals converted by the photodiode 50.

The optical fiber transmitting system 100 further includes a processor chip 80 configured for processing the electrical signals converted by the photodiode 50, and sending control instructions to the laser diode 60. The processor chip 80 is electrically connected to the circuit board 70, thus the circuit board 70 can provide electrical power for the processor chip 80.

In assembly, the photodiode 50, the laser diode 60 and the processor chip 80 are fixedly positioned at the predetermined positions on the circuit board 70. The light directing member 40 is fixed on the circuit board 70 with the second surface 42 substantially parallel to the surface of the circuit board 70, the two lens portions 421 are correspondingly aligned with the photodiode 50 and the laser diode 60. The ends of the light input optical fiber 10 and the light output optical fiber 20 are inserted and fixed in the corresponding through holes 312. The engaging posts 32 are engaged into the corresponding engaging holes 411, the end surface 311 of the connector body 30 towards to the first surface 41 of the light directing member 40.

In use, when signals are input, input optical signals passes through the light input optical fiber 10 to the light directing member 40, and then passes through the first surface 41 of the light directing member 41 into the light directing member 40. The input optical signal is totally reflected by the light reflecting surface 431 of the slot 43 and thus the transmitting path of the input optical signals is approximately refracted 90 degrees. The refracted input optical signals transmits to the lens portion 421 and passes through the lens portion 421 to the photodiode 50. The input optical signals is received and converted into corresponding electrical signals by the photodiode 50. The electrical signals is transmitted to the processor chip 80 for processing. When signals are output, the processor chip generates control instructions and sends the control instructions to the laser diode 60, the laser diode 60 generates corresponding optical signals based on the control instructions. The optical signals is transmitted into the light directing member 40 though the lens portion 421, and is totally reflected by the light reflecting surface 431 of the slot 43. The refracted optical signals pass through the light directing member 40 through the first surface 41. Then, the optical signal is output by the light output optical fiber 20.

The optical fiber transmitting system 100 employs a light directing member 40 for approximately refracting the signal transmitting path 90 degrees. There is no need to refract the light input optical fiber 10 and the light output optical fiber 20 during the assembling of the optical fiber transmitting system 100, therefore, it is easy to assemble the optical fiber transmitting system 100, and the damage to the light input optical fiber 10 and the light output optical fiber 20 because of deforming can be avoided.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An optoelectronic module for optically coupling with an optical fiber connector, the optical fiber connector including a light input optical fiber and a light output optical fiber, the optoelectronic module comprising:
a circuit board;
a photodiode mounted on the circuit board;
a laser diode mounted on the circuit board; and
a light directing member mounted on the circuit board, the light directing member comprising a first surface and a second surface substantially perpendicular to the first surface, the first surface facing the light input optical fiber and the light output optical fiber, the second surface facing the photodiode and the laser diode, the light directing member including a light reflecting surface configured for reflecting light from the light input optical fiber to the photodiode and reflecting light from the laser diode to the light output optical fiber.

2. The optoelectronic module of claim 1, wherein the light directing member comprises two lens portions formed on the second surface, one of the lens portions optically aligned with the photodiode, and the other lens portion optically aligned with the laser diode.

3. The optoelectronic module of claim 2, wherein the lens portions are integrally formed with the second surface.

4. The optoelectronic module of claim 1, wherein the light directing member defines a slot therein, the light reflecting surface located in the slot.

5. The optoelectronic module of claim 1, wherein the light directing member is a transparent block including the light reflecting surface for internally reflecting the light from the laser diode and the light input optical fiber.

6. The optoelectronic module of claim 1, further comprising a processor chip mounted on the circuit board and electrically connected to the laser diode and the photodiode.

7. A light transmitting and receiving module, comprising:
an optical fiber connector, comprising:
a light input optical fiber; and
a light output optical fiber; and
an optoelectronic module, comprising:
a photodiode mounted on the circuit board;
a laser diode mounted on the circuit board; and
a light directing member mounted on the circuit board, the light directing member comprising a first surface and a second surface substantially perpendicular to the first surface, the first surface facing the light input optical fiber and the light output optical fiber, the second surface facing the photodiode and the laser diode, the light directing member including a light reflecting surface configured for reflecting light from the light input optical fiber to the photodiode and reflecting light from the laser diode to the light output optical fiber.

8. The light transmitting and receiving module of claim 1, wherein the optical fiber connector comprises a connector body, the connector body comprises a main body and two engaging posts formed on an end surface of the main body, and the light directing member defines two engaging holes in the first surface for insertion of the engaging posts thereinto.

9. The light transmitting and receiving module of claim 7, wherein the main body defines two through holes corresponding to the light input optical fiber and the light output optical fiber, an end of each of the light input optical fiber and the light output optical fiber is inserted and fixed in a corresponding through hole.

10. The light transmitting and receiving module of claim 7, wherein the engaging posts and the main body are integrally formed with each other.

11. The light transmitting and receiving module of claim 1, wherein the light directing member comprises two lens portions formed on the second surface, one of the lens portions optically aligned with the photodiode, and the other lens portion optically aligned with the laser diode.

12. The light transmitting and receiving module of claim 11, wherein the lens portions are integrally formed with the second surface.

13. The light transmitting and receiving module of claim 1, wherein the light directing member defines a slot therein, the light reflecting surface located in the slot.

14. The light transmitting and receiving module of claim 1, wherein the light directing member is a unitary transparent block including the light reflecting surface for internally reflecting the light from the laser diode and the light input optical fiber.

15. The light transmitting and receiving module of claim 1, further comprising a processor chip mounted on the circuit board and electrically connected to the laser diode and the photodiode.
